(19) United States
(12) Patent Application Publication
(10) Pub. No.: US 2021/0086552 A1
(43) Pub. Date: Mar. 25, 2021

(54) LAMINATED STRUCTURE WITH COLOR AND METHOD FOR CHANGING COLOR THEREOF

(71) Applicant: Paragon Technologies Co., Ltd., Taoyuan City (TW)

(72) Inventors: Ching-Feng YU, Taoyuan City (TW); Hsiu-Ping YU, Taoyuan City (TW)

(21) Appl. No.: 16/576,742

(22) Filed: Sep. 19, 2019

(51) Int. Cl. B44F 1/08; D06Q 1/10; B32B 7/023; B32B 33/00

(52) U.S. Cl. CPC B44F 1/08; D06Q 1/10; B32B 17/06; B32B 33/00; B32B 7/023

(57) ABSTRACT

A laminated structure includes a base layer, a color layer and a reflective layer. The color layer is formed by a metalloid material, has a thickness and is superposed on the base layer. The reflective layer is superposed with the base layer and the color layer. Visible light passes through the thickness of the color layer and is reflected by the reflective layer to present a color. The wave length and color of visible light can be changed by controlling a thickness of the color layer.

### BACKGROUND OF THE INVENTION

### Technical Field

The invention relates to material coloring, particularly to a laminated structure with color and a method for changing color thereof, especially to presenting metallic luster.

### Related Art

With advances of electroplating and deposition technologies, various technologies can be applied to surface treatment of objects, for example, changing color of an object by coating. This is different from conventional painting.

For the sake of lightweight, some mobile phones adopt reinforced plastic to form their outer casings and the outer casings are further coated with a coating containing metal components to generate metallic luster. However, because an antenna of a mobile phone usually abuts against its outer casing, the coating with metal components will adversely affect transmission of the antenna.

### SUMMARY OF THE INVENTION

An object of the invention is to provide a laminated structure with color and a method for changing color thereof, which uses metalloid material to be passed by visible light to present color and the presented color can be changed by adjusting a thickness of the metalloid material.

Another object of the invention is to provide a laminated structure with color, which can present color with metallic luster.

To accomplish the above objects, the invention provides a laminated structure including a base layer, a color layer and a reflective layer. The color layer is formed by a metalloid material, has a thickness and is superposed on the base layer. The reflective layer is superposed with the base layer and the color layer. Visible light passes through the thickness of the color layer and is reflected by the reflective layer to present a color.

To accomplish the above objects, the invention provides a method for changing color of a laminated structure, in which wave length and color of visible light can be changed by controlling a thickness of the color layer.

### BRIEF DESCRIPTION OF THE DRAWINGS

FIG. 1 is an exploded view of the first embodiment of the invention;

FIG. 2 is an assembled schematic view of the first embodiment of the invention;

FIG. 3 is a diagram showing the relationship of coating thickness and the spectrum;

FIG. 4 is an assembled schematic view of the second embodiment of the invention;

FIG. 5 is an assembled schematic view of the third embodiment of the invention; and

FIG. 6 is an assembled schematic view of the fourth embodiment of the invention.

### DETAILED DESCRIPTION OF THE INVENTION

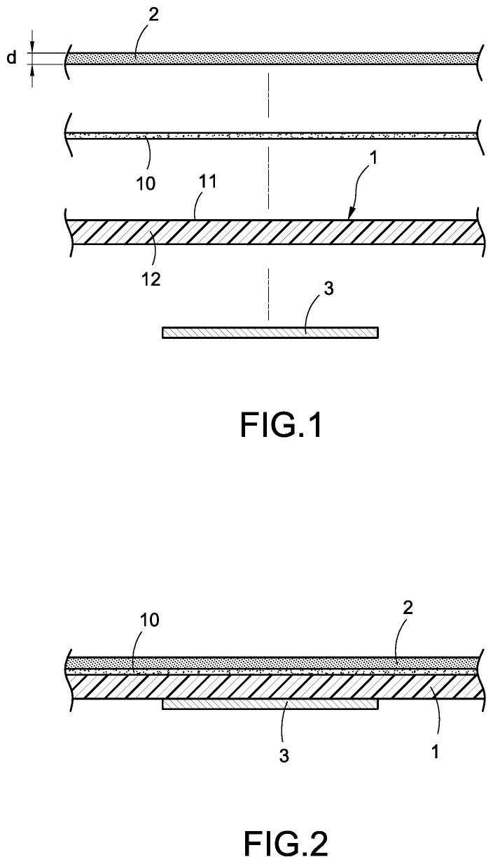

Please refer to FIGS. 1 and 2, which are an exploded view and an assembled schematic view of the first embodiment of the invention. The invention provides a laminated structure and a method for changing color thereof. The laminated structure includes a base layer 1, a color layer 2 and a reflective layer 10.

The base layer 1 is an object, a material or its surface to be colored. The base layer 1 is made of a material with certain strength or hardness, such as metal, alloy, glass or plastic. In this embodiment, the base layer 1 is used to serve as an outer casing of a mobile phone or the like. Under this situation, the base layer 1 is made of plastic and has an outer surface 11 and an inner surface 12. The outer surface 11 is used for being superposed by the color layer 2 and the reflective layer 10. The inner surface 12 can be attached by an electronic component such as an antenna 3.

The color layer 2 is formed by a metalloid material such as boron (B), silicon (Si), germanium (Ge), arsenic (As), antimony (Sb), tellurium (Te), polonium (Po) and astatine (At). Preferably, silicon is adopted, and pure silicon (purity above 99%) is more preferable. To prevent interference to wireless communication of mobile phones, the metalloid material used by the color layer 2 has no metal component. This makes the invention more suitable for 5G mobile communication.

The color layer 2 has a thickness d and superposed on the base layer 1. The color layer 2 may be coated on the base layer 1 or the reflective layer 10 by silicon coating which may be vacuum evaporation, magnetic sputtering or cathode arc vapor. To increase adhesion between the base layer 1 and the color layer 2, sandblasting roughening, atmospheric plasma, corona treatment, vacuum plasma treatment or vacuum ion source can also be used. In addition, the color layer 2 may be further added with surface treatment such as anti-fingerprint or paint protection to increase service life of the color layer 2. The surface treatment of anti-fingerprint may be spraying or vacuum physical vapor deposition.

The reflective layer 10 is superposed with the base layer 1 and the color layer 2. In this embodiment, the reflective layer 10 is superposed on the outer surface 11 of the base layer 1 and sandwiched between the base layer 1 and color layer 2. When visible light pass through the thickness d of the color layer 2, the visible light can be reflected by the reflective layer 10 to make the light source present color on the color layer 2. When visible light has passed through the thickness d of the color layer 2 to reach the base layer 1 or the reflective layer 10, the refraction to the visible light in the color layer 2 can change wavelength of the visible light by the optical property of material such as silicon. Furthermore, both a surface of the base layer 1 or the reflective layer 10 as a background color and its surface roughness will cause spectrum variation to the color presented. Accordingly, users can view different colors with the naked eye.

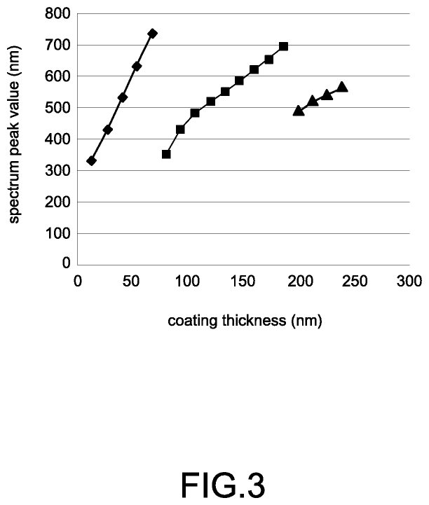

Please refer to FIG. 3. The invention further has an embodiment, in which the base layer 1 or the reflective layer 10 adopts an aluminum plate with black paint as a background color and the color layer 2 adopts silicon coating to form the thickness d. The spectrum peak values obtained by different coating thickness is shown in FIG. 3. According to FIG. 3, a spectrum peak value (i.e., wavelength) and color can be changed by adjusting coating thickness. By observing the relationship between the coating thickness and color, the coating color presents a periodic variation. This variation is relative to thickness and color shade presented is relative to coating thickness, too. When the coating layer exceeds a specific thickness and the reflected light of the coating layer is far greater than the refracted light which has passed through the coating layer in intensity, the color of the coating layer will become the original color of the coating material.

Thus, according to FIG. 3, under the condition of controlling the background color of the base layer 1 and the reflective layer 10, wavelength of visible light can be changed by adjusting thickness of the color layer 2 to present different colors. A preferred or desired color or spectrum can be chosen by a corresponding thickness. More importantly, the color layer 2 is made of a metalloid material, the color presented has metallic luster without interference to wireless communication.

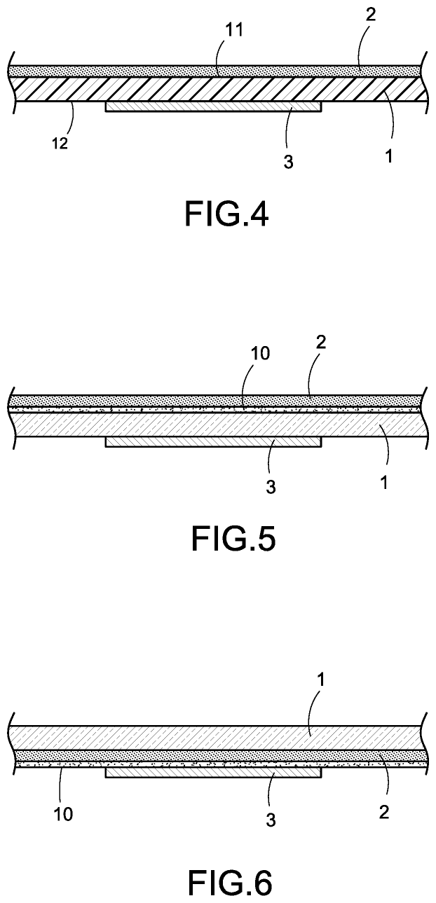

Please refer to FIG. 4, which shows an assembled schematic view of the second embodiment of the invention. In this embodiment, the reflective layer 10 is formed on the outer surface 11 of the base layer 1. In other words, the outer surface 11 of the base layer 1 itself has a reflective effect. For example, the base layer 1 is made of aluminum and its outer surface 11 is painted. Preferably, the color of paint is a deep color such as metallic black. In addition, the base layer 1 may be treated with surface protection to make the base layer 1 a self-protection layer or another color layer. Such surface treatment may be painting, micro-arc oxidation, anodizing, etc.

Please refer to FIG. 5, which shows an assembled schematic view of the third embodiment of the invention. The base layer 1 may be a transparent material such as glass, acrylic, PC or PET. At this time, the reflective layer 10 is formed by an opaque or translucent material such as colored paint, ink, metal film or plastic and is disposed between the base layer 1 and the color layer 2 by spraying, printing or vacuum coating for reflection.

Please refer to FIG. 6, which shows an assembled schematic view of the fourth embodiment of the invention. According to the third embodiment, the color layer 2 is sandwiched between the color layer 2 and the reflective layer 10. The inner surface 12 of the base layer 1 is disposed with the color layer 2 by the above approaches, and then the reflective layer 10 is disposed on the color layer 2.

It will be appreciated by persons skilled in the art that the above embodiments have been described by way of example only and not in any limitative sense, and that various alterations and modifications are possible without departure from the scope of the invention as defined by the appended claims.

What is claimed is:

1. A laminated structure with color, comprising:
a base layer;
a color layer, formed by a metalloid material, having a thickness, and superposed on the base layer; and
a reflective layer, superposed with the base layer and the color layer;
wherein visible light passes through the thickness of the color layer and is reflected by the reflective layer to present a color.

2. The laminated structure of claim 1, wherein the base layer is made of metal, alloy, glass or plastic.

3. The laminated structure of claim 1, wherein the base layer has an outer surface and an inner surface, the outer surface is superposed by the color layer and the reflective layer, and the inner surface is attached by an antenna.

4. The laminated structure of claim 3, wherein the reflective layer is disposed on the outer surface of the base layer and sandwiched between the base layer and the color layer.

5. The laminated structure of claim 3, wherein the outer surface of the base layer is the reflective layer.

6. The laminated structure of claim 1, wherein the color layer is silicon.

7. The laminated structure of claim 6, wherein the color layer is pure silicon with purity of 99%.

8. The laminated structure of claim 1, wherein a color presented by the color layer has metallic luster.

9. The laminated structure of claim 1, wherein the color layer is added with surface treatment of anti-fingerprint or paint protection.

10. The laminated structure of claim 1, wherein the base layer is a transparent material and the reflective layer is formed by an opaque or translucent material.

11. A method for changing color of the laminated structure of claim 1, wherein controlling a thickness of the color layer to change wavelength of visible light to control presented color.
